(19) United States
(12) Patent Application Publication
(10) Pub. No.: US 2004/0212803 A1
(43) Pub. Date: Oct. 28, 2004

(54) Measuring device for movements on a weaving machine

(75) Inventors: Walter Siegl, Staefa (CH); Dietmar Markward, Rueti (DE); Marcel Christe, Rueti (CH)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sultex AG, Rueti (CH)

(21) Appl. No.: 10/806,997

(22) Filed: Mar. 22, 2004

(30) Foreign Application Priority Data
Apr. 22, 2003 (EP) 03405277.9

(51) Int. Cl. G01N 21/84

(52) U.S. Cl. 356/429

(57) ABSTRACT

With the measuring device movements are determined on a weaving machine (1). With this measuring device (2) digital signals can be produced at discrete points in time occurring in a periodic sequence by means of a positional determination of one or more identifiable points (31) which are located on a moved surface (30) and within a two dimensional measuring window (3) of the measuring device. These signals can be evaluated for determining an interval which can be associated with changes in position of the identifiable positions. Optical and electronic components (21, 22, 23, 20) for effecting pattern recognition are integrated in the measuring device. The identifiable positions can be defined by the pattern recognition. The positions of at least some of these positions can be determined at two sequential points in time of the said sequence. The interval associated with the changes in position can be calculated at each of the discrete points in time. Thus the length of a path (L) travelled by the moved surface and also its speed (v,V) can be determined at these points in time.

The invention relates to a measuring device for movements on a weaving machine in accordance with the preamble of claim 1. It also relates to a method for operating the measuring device.

In weaving machines the speeds of threads are often measured with devices in which the thread is in each case subjected to a three-point deflection. Structural changes in the thread can result from this, which result in a reduction of the cloth quality. For this reason contact-free measuring processes have been developed which do not result in a reduction in the quality of the cloth. By way of example, the speed of warp threads is determined by means of two sensors which are arranged one behind the other in the direction of the threads and which register the characteristic structural characteristics of the threads. The sensors produce signals corresponding to the structural features from which the thread speed is calculated electronically by means of a correlation process. The characteristic structural characteristics are, for example, electrical charges which occur naturally on threads and are distributed there randomly (see EP-A-1 033 579). Variable colouring can also be used as features of this kind. The Doppler effect has also been used for the contact-free speed measurement. When using correlation methods or the Doppler effect, electronic devices are necessary which are relatively complicated and thus involve high costs.

The object of the invention is to produce a further measuring device with which movements on a weaving machine can be monitored in particular in which speeds of threads can be calculated and which facilitates an economical measuring process. The object should already be satisfied if the relatively slow movement of warp threads is measurable. This object is solved by the measuring device defined in claim 1.

Movements on a weaving machine are calculated with the measuring device. With this measuring device digital signals can be produced by means of positional determination of one or more identifiable points, which are located on a moved surface and within a two dimensional measuring window of the measuring device, at discrete points in time occurring in a periodic sequence. The signals can be evaluated for determining an interval which can be associated with the changes in position of the identifiable positions. Optical and electronic components are integrated in the measuring device for a pattern recognition. The identifiable points or positions can be defined by the pattern recognition. The positions of at least some of these points or positions can be determined at two sequential points in time of the said sequence. The interval associated with the changes in position can be calculated at each of the discrete points in time and thus the length of a path travelled by the moved surface and also its speed at these points in time.

The dependent claims 2 to 5 relate to advantageous embodiments of the measuring device in accordance with the invention. Methods for operating this measuring device are the subject-matter of claims 6 to 10 respectively.

The invention will now be explained in the following with reference to the drawings. They show:

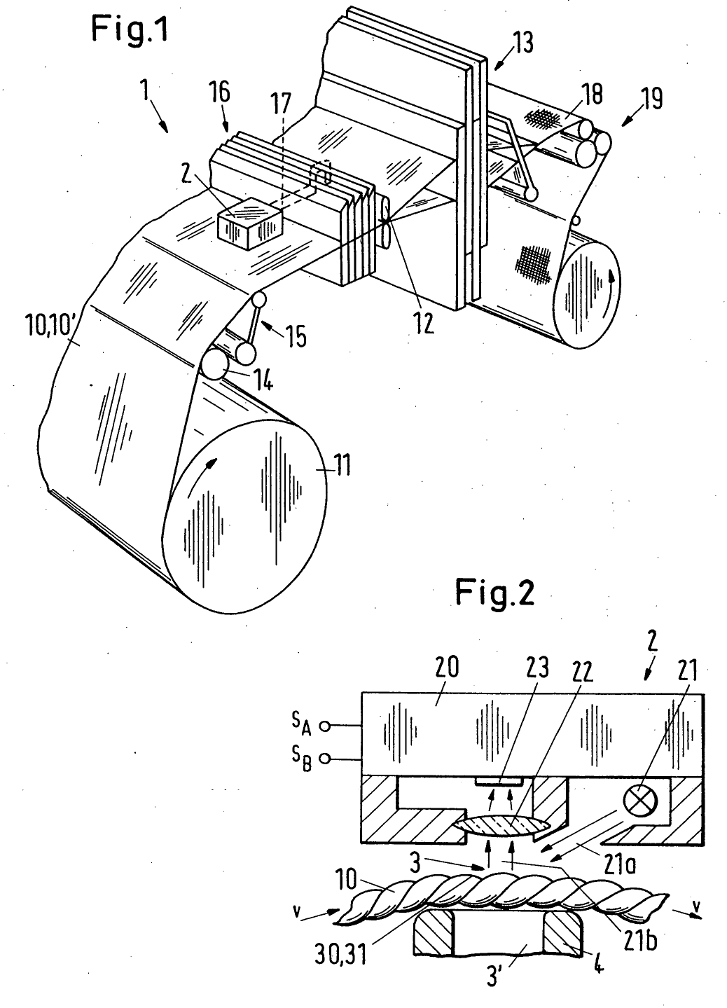

FIG. 1 a weaving machine with a measuring device in accordance with the invention,

FIG. 2 a schematic illustration of a measuring head of the measuring device,

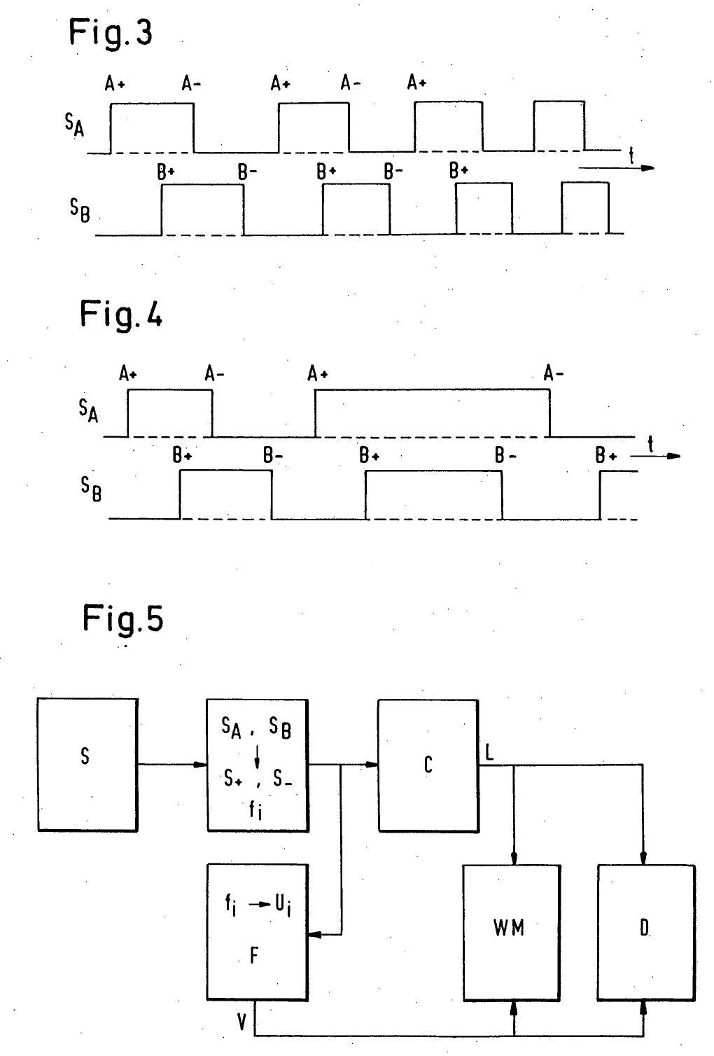

FIGS. 3, 4 schematic diagrams of measuring signals and

FIG. 5 a block diagram of a method in accordance with the invention.

The weaving machine 1 of FIG. 1 carries a measuring device 2 in accordance with the invention with a measuring head for the contact-free detection of a thread speed v, with which warp threads 10 of a warp 10′ are drawn off from a warp beam 11. Further components of the weaving machine 1 are: a cross-beam 12, heald frames 13, a deflection beam (14), a warp tensioner 15 and warp thread monitor (warp stop motion) 16. The reference numeral 18 relates to the cloth produced above a cloth take-off 19. The measuring head of the measuring device 2 is held secure at a spatially fixed position with a fixing means 17, which produces a connection to the cross-beam 12 between the warp thread monitors 16. In this arrangement the measuring had can be placed loosely into a non-illustrated holder of the fixing means 17. To determine the warp thread speed v, the measuring head of the measuring device 2 can be arranged above or below the warp 10′. In the example of FIG. 1 it is located above the warp 10′ between the warp beam 11 and the warp thread monitors 16. The threads 10 move there in a largely common plane.

The measuring head of the measuring device 2 is shown schematically in FIG. 2—partially in section. Optical and electronic components are integrated in the compactly designed measuring device 2. A light source 21 projects a light beam 21a onto positions 31 which are to be observed through a non-illustrated optical system, namely on to a moved surface 30 inside a “measuring window 3” which forms a two-dimensional section of the surface 30. Light 21b scattered in the measuring window 3 is projected through a lens 22 onto an image sensor 23 in which an image of the lit surface 30 is produced. The image is processed with an electronic circuit 20 and converted to a result in the form of output signals S_{A} and S_{B}.

A prerequisite for the measuring process is that the surface 30 has a structuring by means of which a filigree shadow pattern emerges in which surface elements of different shades of grey can be distinguished. Identifiable positions 31 can be defined on the basis of the shadow pattern. A movement of the surface 30 by the measuring window can be observed by determination of position of one or more identifiable points or positions 31. Digital signals are produced by means of the image sensor 23 and the electronic circuit 20 at discrete points in time occurring in a periodic sequence. This sequence of points in time can be produced with a flashing light source 21, for example with a light-emitting diode LED. If the diode flashes 1500 times a second, then the length of the periodic sequence between sequential points in time amounts to ⅔ ms. A gap is determined from the digital signals which is associated with the positional changes of the identifiable positions. The signals S_{A}, S_{B} can tapped off at the output of the electronic circuit 20 and are approximately right-angled curves such as are illustrated in FIGS. 3 and 4.

The measuring device 2 contains optical and electronic components for pattern recognition. Identifiable positions 31 are defined by the pattern recognition. The positions of at least some of these positions are determined. The path which the positions 31 travel between two sequential points in time of the named sequence is a distance proportional to the speed v. This distance associated with the change in position is calculated for each of the discrete points in time. This distance divided by the length of time between two of the sequential points in time (for example ⅔ ms) results in the speed v to be measured.

In the measuring zone the warp threads 10 are advantageously brought into contact with an element 4, through which a transverse oscillation of the warp threads 10 can be largely suppressed. Thus the threads 10 can be led without coming into contact with the measuring device 2 past its lens 22. The element 4 has an opening 3′ in the region of the measuring window 3, so that no disturbing signals are produced due to a reflecting base layer. The vibrations of the warp threads 10 can be suppressed from underneath—as shown in FIG. 2—and also from above however (not illustrated).

The measuring device 2 can be arranged at a different position of the warp 10′ rather than directly next to the warp thread monitor 16. The take-off speed of the cloth 18 produced can also be measured by a corresponding positioning in the region of the cloth take-off 19. Alternatively the measuring device 2 can be arranged at the warp beam 11 in order to determine its rotational speed.

Further possibilities of use exist for the measuring device 2 in accordance with the invention. Thus a use with terry weaving machines is particularly advantageous in which respective measuring heads can be provided for a ground warp and/or nap warp.

Furthermore, on a weaving machine 1, in which the warp is taken off by at least two part warp beams, one measuring head is associated with each part warp beam. The warp thread speeds v of the part warps 10′ are measured with the measuring heads. The warp thread take-off can thus be synchronised—using a control unit (not illustrated)—by matching the warp thread speeds v to one another.

A mass-produced component with integrated photo-sensor and image processor which is inserted into optical computer mice is advantageously used as an image sensor 23 for economic reasons. This electronic input equipment includes an image sensor with a small number of pixels (matrix with 16×16 pixels; 64 shades of grey respectively) one lens system and a very fast DSP (digital signal processor). A speed to be measured corresponds to the speed with which a computer mouse is guided by hand and which amounts to approximately 35 cm/s at a maximum. This maximum value is sufficient to measure the speed v of the warp threads 10. A thread acceleration can also be measured which amounts to up to 2 m/s².

The speed v of a thread 10 can be calculated or also that of a plurality of threads if these are simultaneously recorded in the measuring window 3 of the sensor 23. The measuring window 3 is square and has a side length of 1-1.3 mm. The thread 10 which has to have a surface structure (which applies to a fibre yarn but not always for a monofilament) can be measured by the measuring device 2 if it has a minimum thickness of preferably 0.01 mm.

The named image processor makes available “quadrature signals” in the form of two pairs XA, XB and YA, YB at the output, wherein these pairs of signals correspond to both directions of movement along an x or y axis. In the measuring device 2 in accordance with the invention only one of the two pairs of signals is needed, which is given the reference numerals S_{A}, S_{B} here. Both signals can be illustrated as diagrams which can be described as a time sequence of rising flanks A+ and B+ and falling flanks A− and B−. Each flank corresponds to a counter point (+1 or −1) which is associated with a displacement of the shadow pattern registered in the image sensor 23 by a pre-determined distance (for example 0.1 mm). The closer the flanks of the signals S_{A} and S_{B} follow each other on the time axis t, the greater the speed v observed. As an example, an increase of the speed v is illustrated in the diagrams of FIG. 3. If the movement always takes place in the same direction then a time sequence results according to the following pattern . . . A+/B+/A−/B−/A+/B+/A−/B−/A+/B+ . . . . This is the case in the example of FIG. 3. The flanks of the two signals S_{A} and S_{B} appear regularly offset from one another. In the diagrams of FIG. 4 a sequence . . . A+/B+/A−/B−/A+/B+/B−/A−/A+/B+ . . . is present. The regular offset is interrupted in the region B+/B−/A−. In the interval lying between the two flanks B+ and B−, the speed v has changed direction.

In the movement of the warp threads changes in direction of the speed v take place regularly. Since only an average speed V in the forward direction is needed for the regulation of the weaving machine, the signals S_{A} and S_{B} are transformed into a sequence of signals S₊=+1 and S₋=−1 for one step in the forward or reverse direction respectively. By addition of the signals S₊ and S₋ a number is obtained which is proportional to the path travelled in the forward direction. A frequency fₛ (s=+ or −) can also be respectively estimated from the signals S₊ and S₋ which is proportional to the average speed V.

The measuring device in accordance with the invention facilitates a method in which a reverse movement can be compensated for without error by means of filtering and time synchronised scanning with the weaving machine cycle.

A block diagram is shown in FIG. 5 on the basis of which the transmission and the transformation of the signals is shown. The quadrature signals S_{A} and S_{B} are transmitted from the optical path sensor S (image sensor 23 of the measuring device 2) to a transformer, in which the signals S₊ and S₋ and also signals for the frequencies fₛ are produced. The average speed V is calculated from the frequencies fₛ which are transformed into voltages Uₛ and using a filter F (1 Hz filter). (In particular the contributions produced by the reverse movements are averaged out. These contributions are compensated by corresponding contributions of the forward movements.) The path travelled L in the forward direction is determined from the signals S₊ and S₋ in a counter C. On the one hand the two parameters L and V are displayed on a display D and on the other hand they are used for the regulation of the weaving machine WM.

1. A measuring device for movements on a weaving machine (1), with which measuring device (2) digital signals can be produced at discrete points in time occurring in a periodic sequence, by means of positional determination of one or more identifiable points or positions (31) which are located on a moved surface (30) and within a two dimensional measuring window (3) of the measuring device, these signals being able to be evaluated for determining an interval which can be associated with the changes in position of the identifiable positions,
characterised in that optical and electronic components (21,22,23,20) are integrated in the measuring device for effecting a pattern recognition, in that the identifiable positions can be defined by the pattern recognition, in that the positions of at least some of these positions can be determined at two sequential points in time of the said sequence, in that the interval associated with the changes in position can be calculated at each of the discreet points in time and thus the length of a path (L) travelled by the moved surface and also its speed (v, V) can be determined at these points in time.

2. A measuring device in accordance with claim 1 characterised in that it is arranged for the determination of the warp thread speed (v) at the weaving machine above or below a warp (10′) and also between a warp beam (11) and warp thread monitors (16) and in that the warp threads (10) are in contact with an element (4) in the measuring region, through which a transverse oscillation of the warp threads can be suppressed.

3. A measuring device in accordance with claim 1 characterised in that a measuring head of the measuring device (2) is arranged in the region of a cloth take-off (19) where the take-off speed of the cloth (18) which has been produced can be determined.

4. A measuring device in accordance with claim 1 characterised in that a measuring head of the measuring device (2) is arranged at the edge of the warp beam (11) where the rotational speed of the warp beam can be determined.

5. A measuring device in accordance with claim 1, characterised in that the warp (10′) at the weaving machine (1) can be drawn off by at least two part warp beams, in that the measuring device (2) includes a plurality of measuring heads, in that each part warp beam is associated with one of the measuring heads, namely for the measuring of the warp thread speeds corresponding to the part warp beams and in that a control unit is part of the weaving machine, by which the warp thread take-off can be synchronised by equalising the warp thread speeds.

6. A method for operating the measuring device (2) in accordance with claim 1, characterised in that a pattern recognition is carried for the identification of positions (31) out on a moved surface (30) by means of an image sensor (23), in that the positions of at least some of these positions are determined for a periodic sequence of discreet points in time at two sequential points in time and in that one interval associated with the changes in position is calculated at each of the discreet points in time.

7. A method in accordance with claim 6, characterised in that an image processor is used which produces quadrature signals (SA, SB) corresponding to the changes in position and in that a length of a path (L) travelled by the moved surface and also its speed (v) is determined at the discreet points in time from the quadrature signals by means of electronic calculation.

8. A method in accordance with claim 7, characterised in that the length of a path (L) travelled by warp threads in the forward direction and also an intermediate speed (V) of the warp threads is determined.

9. A method in accordance with claim 8, characterised in that in determining the mean speed (V) a filter (F), is used, in particular a 1 Hz filter.

10. A method in accordance with claim 6 characterised in that a reverse movement is compensated for without error by filtering and time synchronised sampling with the weaving machine cycle.
